(19) United States
(12) Patent Application Publication
(10) Pub. No.: US 2006/0093427 A1
(43) Pub. Date: May 4, 2006

(54) Marker tip

(76) Inventor: Dale Dean Timm JR., Solana Beach, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/976,635

(22) Filed: Oct. 29, 2004

(51) Int. Cl. B43K 5/00

(52) U.S. Cl. 401/198

(57) ABSTRACT

A marker for use on printed materials is herein disclosed. The marker includes a hollow body having an ink reservoir contained therein. One end of the hollow body has an opening in which is received a tip, one end of the tip being in contact with the ink in the ink reservoir. The opposite end of the tip has formed thereon at least one relatively sharp edge. The tip is made of a porous material that transmits ink from the ink reservoir to the printed material at a desired rate of flow by means of capillary action.

### CLAIM OF PRIORITY

This application claims the benefit of U.S. Provisional Application No. ______, filed on Oct. 26, 2004, entitled MARKER TIP, and having express mail label number EV472666797 US (Attorney Docket Number 200403521-1).

### BACKGROUND OF THE INVENTION

The present invention relates to a marker that reduces smearing of ink when used on printed materials. Inkjet printers enjoy widespread use. They are inexpensive, flexible, and produce high quality images. However, some inks used in inkjet printing are not completely waterfast and are accordingly susceptible of smearing when manipulated after printing.

Smearing is particularly pronounced when the text or image is handled or otherwise modified immediately after printing, when the inks used are still wet. However, even after the inkjet inks have dried, images and text are still subject to smearing, as the solvents typically used in highlighter inks may solubilize the inkjet inks, which are then smeared by the tip of the highlighter.

Referring to FIG. 1, there is illustrated a typical prior art marker used for highlighting text or coloring images. The prior art marker 100 has a tip 102 with a distal end 104 that is relatively flat or which has a large radius. The large distal ends are often used to increase the amount of ink that may be applied to the media being written upon. As the tip 102 of the prior art marker 100 is drawn across the surface of a printed medium 106 in the direction of arrow 108, a first portion 110 of the tip 102 transfers ink from the tip 102 of the marker to the medium 106. The ink transferred from the first portion 110 of the tip 102 is generally sufficient to solubilize the inkjet inks that have been laid down on the medium 106. Thereafter, a second portion of the tip 112 transfers additional ink from the tip 102 to the medium 106, but also acts to scour or abrade the surface of the medium 106. This scouring action is a result of the inherent abrasiveness of the material from which the tip 102 is made. In many cases, the tip 102 of a prior art marker 100 is made of a fibrous material such as felt or the like. The scouring action of the second portion 112 tends to smear the inks applied to medium 106. Because of these limitations, there is a need for a marker having a tip that can apply a visually sufficient amount of ink to media printed with inkjet inks and other non-fast inks that avoids or limits smearing of the images.

These and other objects, aspects, features and advantages of the present invention will become more fully apparent upon careful consideration of the following detailed description of some embodiments of the present invention and the accompanying drawings, which may be disproportionate for ease of understanding, wherein like structure and steps are referenced generally by corresponding numerals and indicators. The invention further provides methods and apparatus of varying scope.

### BRIEF SUMMARY OF THE INVENTION

The present invention satisfies the needs of the prior art by providing a marker constructed and arranged to apply sufficient ink to a medium without smearing the ink. The marker includes a hollow body that may be cylindrical or another useful or ergonomic shape. The body of the marker encloses an ink reservoir and has an opening in one end that communicates with the ink reservoir. A tip is inserted and retained in the opening of the marker body such that an upper, proximal end of the tip is in contact with the ink in the reservoir. A lower, distal end of the tip is has a narrow edge formed thereon for applying ink transmitted through the tip by means of capillary action to a medium.

### DESCRIPTION OF THE DRAWINGS

FIG. 1 is a schematic illustration of a prior art marker tip being drawn across a printed medium.

FIG. 2 is a schematic illustration of the front of an embodiment of a marker tip of the present invention.

FIG. 3 is a schematic illustration of the side of the embodiment of the marker tip of FIG. 2.

FIG. 4 is a side schematic illustration of another embodiment of a marker tip according to the present invention.

FIG. 5 is a front schematic illustration of the marker tip of FIG. 4.

FIG. 6 is a side schematic illustration of yet another embodiment of a marker tip according to the present invention.

FIG. 7 is a front schematic illustration of the marker tip of FIG. 6.

FIG. 8 is a side schematic illustration of an embodiment of a marker tip according to the present invention that includes a ferrule.

FIG. 9 is a front schematic illustration of the marker tip of FIG. 8.

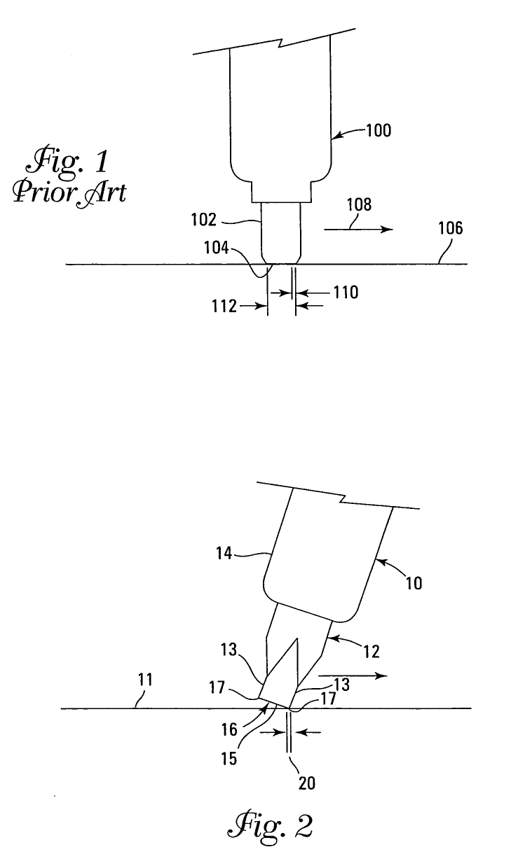

### DETAILED DESCRIPTION

In the following detailed description of some embodiments of the present invention, reference is made to the accompanying drawings that form a part hereof and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural changes may be made without departing from the scope of the present invention. The following description is, therefore, not to be taken in a limiting sense, and the scope of the present invention is defined only by the appended claims and equivalents thereof.

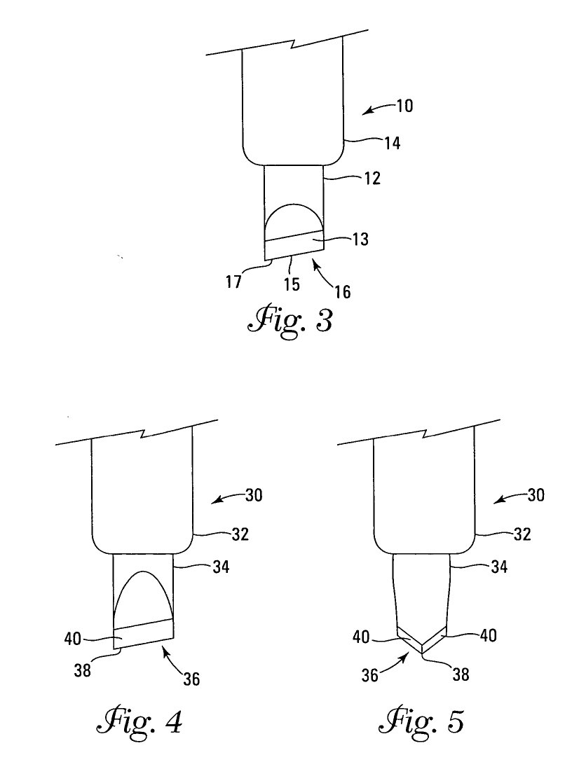

A marker 10 according to the present invention overcomes the limitations of the prior art by providing a tip structure that provides sufficient ink to the surface of the media, without scouring the surface and smearing the images on the media. The marker 10 illustrated in FIGS. 2 and 3 includes a tip 12 made of a relatively rigid and porous molded material. The material from which the tip 12 is fashioned may be molded into many desired shapes, preferably having smooth surfaces. In some embodiments, the tip 12 may be formed using a suitable machining process. The tip 12 is mounted in an end of a hollow tube 14 such that an upper end (not shown) of the tip 12 is received within the tube 14 and is in contact with ink contained in a reservoir (not shown) of ink within the tube 14. Ink is conducted from the reservoir in the tube 14 through the body of the tip 12 to a distal end 16 of the tip 12. Touching the distal end 16 of the tip 12 to media 11 allows ink to flow from the tip 12 onto the media 11.

The tip 12 of the marker 10 is in its base form, generally cylindrically or slightly frustoconical. A distal end 16 of the tip 12 is shaped by a pair of planar facets 13 that are formed into the tip 12 in a generally planar parallel relationship to one another and a bottom surface 15 that intersects the facets 13 in a substantially perpendicular manner. Accordingly, the distal end 16 of the tip 12 is generally rectangular in cross section and has relatively sharp edges 17. The tip 12 is preferably fashioned of a moldable, smooth material, though in some embodiments, the tip 12 may be formed by cutting portions thereof away in a suitable machining process. The distal end 16 of tip 12 may be inclined in orientation with respect to an axis of the marker 12 to allow the marker 10 to be held in a more natural writing attitude by a user as can best be seen in FIG. 3.

In use, the marker 10 is addressed to the media 11 such that one of the sharp edges 17 is addressed to the media 11 in substantially full linear contact. As the tip 12 is drawn across the media 11, the capillary nature of the tip 12 dispenses ink form the tube 14 of the marker 12 onto the media 11. Note that in order to maintain contact between the edge 17 of the tip 12 and the media 11, the marker 10 is angled as shown in FIG. 2. In this manner, the total area of contact 20 between the tip 12 and the media 11 is minimized. Scouring, and subsequently smearing of images on the media 11, is thereby reduced. The edges 17 of the distal end 16 of the tip 12 need not be perfectly linear. However, any radius incorporated into the edges 17 should be small enough to approximate a linear edge and yet have sufficient surface area to transmit ink at a desired rate from the tube 14 to the media 11 via capillary action. In one embodiment, the edges 17 of the tip 12 have a radius of no more than forty (40) thousandths of an inch. In another embodiment, the edges 17 of the tip 12 have a radius that is no more than twenty (20) thousandths of an inch.

FIGS. 4 and 5 illustrate side and front views, respectively, of another embodiment of a marker 30 according to the present invention. Marker 30 includes a tube 32 that incorporates an ink reservoir (not shown) therein. A tip 34 is received and retained in an open end of tube 32 such that an upper end of tip 34 (not shown) is in contact with the ink in the ink reservoir within tube 32. The tip 34 is preferably fashioned of a moldable, smooth material, though in some embodiments, the tip 34 may be formed by cutting portions thereof away in a suitable machining process. The basic shape of the tip 34 is generally cylindrical or slightly frustoconical and has a distal end 36 having a relatively sharp edge 38 that is defined by first and second facets 40. These facets 40 may be planar or curvilinear, though in the illustrated embodiment, the facets 40 are shown as being planar. Note also that the sharp edge 38 may be linear as shown in the illustrated embodiments, but may also be curvilinear in shape, so long as it retains its “sharp” aspect. In one embodiment, the tip 34 has a complex shape in which facets 40 sharpen a taper begun by facets 41.

The edge 38 of the distal end 36 of the tip 34 need not be perfectly sharp. However, any radius incorporated into the edge 38 should be small enough to approximate a sharp linear, and in some embodiments a curvilinear, edge and yet have sufficient surface area to transmit ink at a desired rate from the tube 32 to the media (not shown) via capillary action. In one embodiment, the edge 38 of the tip 34 has a radius of no more than forty (40) thousandths of an inch. In another embodiment, the edge 38 of the tip 34 has a radius that is no more than twenty (20) thousandths of an inch. While the edge 38 is in the illustrated embodiments inclined with respect to an axis of symmetry of the tube 32 to facilitate an ergonomic grip while in use, the edge 38 may also be perpendicular to an axis of the tube 32.

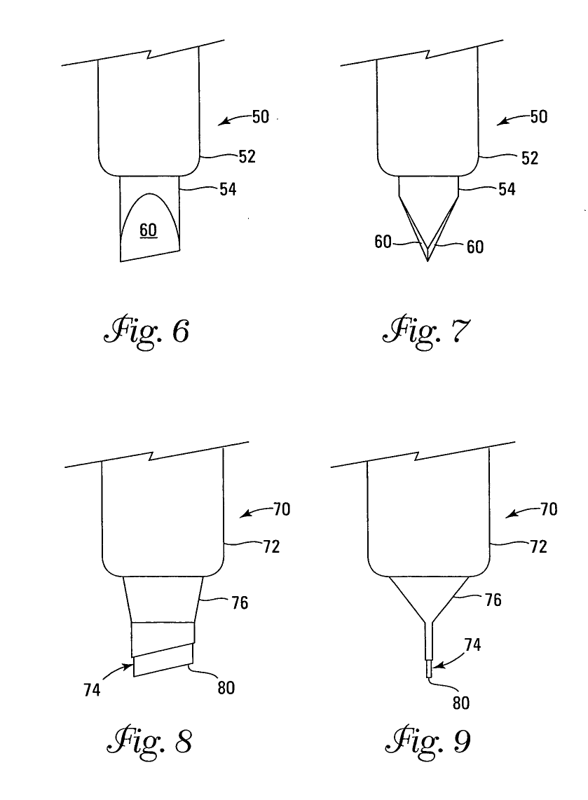

FIGS. 6 and 7 illustrate side and front views, respectively, of yet another embodiment of a marker 50 of the present invention. Marker 50 includes a tube 52 that incorporates an ink reservoir (not shown) therein. A tip 54 is received and retained in an open end of tube 52 such that an upper end of tip 54 (not shown) is in contact with the ink in the ink reservoir within tube 52. The tip 54 is preferably fashioned of a moldable, smooth material, though in some embodiments, the tip 54 may be formed by cutting portions thereof away in a suitable machining process. The basic shape of the tip 54 is generally cylindrical or slightly frustoconical. The distal end 56 of the tip 54 has a relatively sharp edge 58 defined by facets 60.

The edge 58 of the distal end 56 of the tip 54 need not be perfectly linear. However, any radius incorporated into the edge 58 should be small enough to approximate a linear edge and yet have sufficient surface area to transmit ink at a desired rate from the tube 52 to the media (not shown) via capillary action. In one embodiment, the edge 58 of the tip 54 has a radius of no more than forty (40) thousandths of an inch. In another embodiment, the edge 58 of the tip 54 has a radius that is no more than twenty (20) thousandths of an inch. While the edge 58 is in the illustrated embodiments inclined with respect to an axis of symmetry of the tube 52 to facilitate an ergonomic grip while in use, the edge 58 may also be perpendicular to an axis of the tube 52.

FIGS. 8 and 9 illustrate side and front views, respectively, of an embodiment of a marker 70 that includes a supporting ferrule. Marker 70 includes, like the previous embodiments, a tube 72 that incorporates an ink reservoir (not shown) therein. A tip 74 is received and retained in an open end of tube 72 such that an upper end of tip 74 (not shown) is in contact with the ink in the ink reservoir within tube 72. A supporting ferrule 76 is formed around the top 74 such that only a radiused edge 80 of the tip 74 is exposed. The ferrule 76 stiffens the tip 74 and couples the tip 74 to the tube 72.

The edge 80 of the tip 74 is generally cylindrical in shape and presents a relatively small radius to a medium to which ink is to be applied. The radius of the edge 80 is sufficient to facilitate the transmission of ink through the tip 74 by capillary action to the media at a desired rate and without scouring the surface of the media. In one embodiment, the chord width of the portion of the cylindrical edge 80 of the tip 74 that contacts the media 10 during use is no more than forty (40) thousandths of an inch. In another embodiment, the chord width of the portion of the cylindrical edge 80 of the tip 74 that contacts the media 10 during use is no more than twenty (20) thousandths of an inch. While the edge 80 is in the illustrated embodiments inclined with respect to an axis of symmetry of the tube 72 to facilitate an ergonomic grip while in use, the edge 80 may also be perpendicular to an axis of the tube 72.

### CONCLUSION

Although specific embodiments have been illustrated and described herein, it is manifestly intended that this invention be limited only by the following claims and equivalents thereof.

What is claimed is:

1. A marker comprising:
a hollow body having an ink reservoir contained therein, the hollow body having an opening in an end thereof that fluidically connects the ink reservoir to the exterior of the hollow body;
a tip having a proximal end and a distal end, the proximal end of the tip being received and retained in the opening of the hollow body such that the proximal end of the tip is in contact with the ink in the ink reservoir, the distal end of the tip having a sharp edge formed by the intersection of a first facet and a second facet formed in the tip, the tip being formed of a porous material capable of transmitting ink from the ink reservoir to the sharp edge of the distal end of the tip by means of capillary action.

2. The marker of claim 1 wherein the distal end comprises two sharp edges.

3. The marker of claim 1 wherein the first and the second facets have a shape chosen from a group consisting of planar and curvilinear.

4. The marker of claim 1 wherein the sharp edge formed in the distal end of the tip by the first and second facets is substantially linear.

5. The marker of claim 1 wherein the sharp edge formed in the distal end of the tip by the first and second facets is curvilinear.

6. The marker of claim 1 wherein the edge formed in the distal end of the tip by the first and the second facets has a width of no more than 40 thousandths of an inch.

7. The marker of claim 1 wherein the edge formed in the distal end of the tip by the first and the second facets has a width of no more than 20 thousandths of an inch.

8. The marker of claim 1 wherein the tip of the marker is surrounded and supported by a ferrule that is coupled at one end thereof to the hollow body of the marker.

9. The marker of claim 1 wherein the material from which the tip is formed is substantially rigid.

10. The marker of claim 1 wherein the edge of the distal end of the tip is inclined with respect to an axis of the hollow body.

11. A marker comprising:
a hollow body having an ink reservoir contained therein, the hollow body having an opening in an end thereof that fluidically connects the ink reservoir to the exterior of the hollow body;
a tip having a proximal end and a distal end, the proximal end of the tip being received and retained in the opening of the hollow body such that the proximal end is in contact with the ink in the ink reservoir, the distal end of the tip having a cylindrical edge, the tip being formed of a porous material capable of transmitting ink from the ink reservoir to the cylindrical edge of the distal end of the tip by means of capillary action.

12. The marker of claim 11 wherein the cylindrical edge formed in the distal end of the tip is one of linear and curvilinear

13. The marker of claim 11 wherein the tip of the marker is surrounded and supported by a ferrule that is coupled at one end thereof to the hollow body of the marker.

14. The marker of claim 11 wherein the material from which the tip is formed is substantially rigid.

15. The marker of claim 11 wherein the edge of the distal end of the tip is inclined with respect to an axis of the hollow body.

16. The marker of claim 11 wherein a chord width of the portion of the cylindrical edge of the distal end of the tip that contacts a recording medium is no more than 40 thousandths of an inch.

17. The marker of claim 11 wherein a chord width of the portion of the cylindrical edge of the distal end of the tip that contacts a recording medium is no more than 20 thousandths of an inch.

18. A method of applying ink to media printed with non-waterfast inks, comprising:
providing a marker comprising a hollow body having an ink reservoir contained therein, the hollow body having an opening in an end thereof that fluidically connects the ink reservoir to the exterior of the hollow body and a tip having a proximal end and a distal end, the proximal end of the tip being received and retained in the opening of the hollow body such that the proximal end of the tip is in contact with the ink in the ink reservoir, the distal end of the tip having an edge formed by the intersection of a pair of planar facets formed in the tip, the tip being formed of a porous material capable of transmitting ink from the ink reservoir to the sharp edge of the distal end of the tip by means of capillary action; and,
drawing the sharp edge of the distal end of the tip across the media to apply ink thereto.

19. A method of applying ink to media printed with non-waterfast inks, comprising:
providing a marker comprising a hollow body having an ink reservoir contained therein, the hollow body having an opening in an end thereof that fluidically connects the ink reservoir to the exterior of the hollow body and a tip having a proximal end and a distal end, the proximal end of the tip being received and retained in the opening of the hollow body such that the proximal end is in contact with the ink in the ink reservoir, the distal end of the tip having a cylindrical edge, the tip being formed of a porous material capable of transmitting ink from the ink reservoir to the cylindrical edge of the distal end of the tip by means of capillary action; and,
drawing the sharp edge of the distal end of the tip across the media to apply ink thereto.
